(19) United States
(12) Patent Application Publication
(10) Pub. No.: US 2020/0115846 A1
(43) Pub. Date: Apr. 16, 2020

(54) REINFORCEMENT FIBERS WITH IMPROVED STIFFNESS

(71) Applicant: OCV Intellectual Capital, LLC, Toledo, OH (US)

(72) Inventors: David R. Hartman, Granville, OH (US); David L. Molnar, Newark, OH (US); Christian Espinoza Santos, New Albany, OH (US); Daryl Wernette, Johnstown, OH (US); Michael Bechtel, Fredericktown, OH (US); Julia Faeth, Westerville, OH (US)

(21) Appl. No.: 16/603,121

(22) PCT Filed: Apr. 5, 2018
(86) PCT No.: PCT/US18/26192

§ 371 Date: Oct. 4, 2019

Related U.S. Application Data
(60) Provisional application No. 62/482,682, filed on Apr. 6, 2017.

(51) Int. Cl. D06M 15/356; C03C 25/28; C03C 25/47; C09D 139/06

(52) U.S. Cl. CPC D06M 15/3562; C03C 25/28; D06M 2101/40; C09D 139/06; C03C 25/47

(57) ABSTRACT

A stiffened reinforcement fiber is provided that includes a surface treatment disposed thereon. The surface treatment comprises at least one film former. The stiffened reinforcement fiber has a stiffness that is at least 50% higher than an otherwise identical reinforcement fiber that has not been surface treated.

### RELATED APPLICATIONS

This application claims priority to and all benefit of U.S. Provisional Patent Application Ser. No. 62/482,682, filed on Apr. 6, 2017, for REINFORCEMENT FIBERS WITH IMPROVED STIFFNESS, the entire disclosure of which is fully incorporated herein by reference.

### BACKGROUND

Fiber reinforced composite materials consist of fibers embedded in or bonded to a matrix material with distinct interfaces between the materials. Generally, the fibers are the load-carrying members, while the surrounding matrix keeps the fibers in the desired location and orientation, acts as a load transfer medium, and protects the fibers from environmental damage. Common types of fibers in commercial use today include various types of glass, carbon, and synthetic fibers.

Carbon fibers present processing difficulties in many applications, which may lead to slower and more costly product manufacturing. For instance, carbon fibers tend to be limp, lacking inherent stiffness, which causes difficulty in chopping the fibers. Carbon fibers further have low abrasion resistance and thus readily generate fuzz or broken threads and may release particulate material into the air during downstream processing applications. Additionally, due at least in part to their hydrophobic nature, carbon fibers do not interface or wet (i.e., take and hold an aqueous coating) as easily as other reinforcement fibers, such as glass fibers, in traditional resin matrices. Wetting refers to the ability of the resin to uniformly spread over and bond to the fiber surface.

Thus, it is desirable to improve the processability of reinforcement fibers, such as carbon fibers, to improve downstream product manufacturing.

### SUMMARY

In accordance with various aspects of the general inventive concepts, a reinforcement fiber is provided that includes a surface treatment disposed therein. The surface treatment comprises at least one film former. The reinforcement fiber has a stiffness that is at least 50% higher than an otherwise identical reinforcement fiber that has not been surface treated.

In some exemplary embodiments, the film former includes polyvinylpyrrolidone. In some exemplary embodiments, the polyvinylpyrrolidone has a molecular weight of 1,000,000 to 1,700,000.

In some exemplary embodiments, the reinforcement fiber comprises carbon.

In some exemplary embodiments, the surface-treated reinforcement fiber has a stiffness that is at least 80% higher than an otherwise identical reinforcement fiber that has not been surface treated.

In accordance with various aspects of the general inventive concepts, a reinforcement fiber is provided having a surface treatment disposed thereon that comprises about 0.5 to about 3.0 wt. % active solids. The reinforcement fiber has a stiffness that is at least 50% higher than an otherwise identical reinforcement fiber that has not been surface treated.

In accordance with various aspects of the general inventive concepts, a stiffened carbon fiber bundle is provided. The stiffened carbon fiber bundle comprises no greater than 15,000 filaments and has a surface treatment coated thereon. The stiffened carbon fiber bundle has a stiffness that is at least 50% higher than an otherwise identical carbon fiber bundle that does not include the surface treatment. In some exemplary embodiments, the carbon fiber bundle comprises no greater than 12,000 filaments, or between about 1,000 and about 6,000 filaments.

In accordance with various aspects of the general inventive concepts, a stiffened carbon fiber ribbon is provided, wherein the stiffened carbon fiber ribbon comprises at least 24,000 filaments. The stiffened carbon fiber ribbon has a surface treatment disposed thereon that comprises about 0.5 to about 3.0 wt. % active solids. The stiffened carbon fiber ribbon has a stiffness that is at least 50% higher than an otherwise identical carbon fiber ribbon that does not include the surface treatment.

In accordance with various aspects of the general inventive concepts, a method for increasing the stiffness of a reinforcement fiber is provided. The method includes applying a surface treatment to the reinforcement fibers that comprises one or more of a coating composition, heat treatment, and exposure to humidity. The surface treatment increases the stiffness of the reinforcement fiber by at least 50% compared to an otherwise identical reinforcement fiber that has not been surface treated.

In some exemplary embodiments, the reinforcement fiber comprises at least one of glass, carbon, aramid, polyesters, polyolefins, polyamides, silicon carbide (SiC), and boron nitride fibers.

In accordance with various aspects of the general inventive concepts, a fiber-reinforced composite is provided. The fiber-reinforced composite includes a plurality of stiffened reinforcement fibers having a surface treatment disposed thereon and a polymer resin material. The stiffened reinforcement fibers have a stiffness that is at least 50% higher than an otherwise identical reinforcement fiber that has not been surface treated.

In accordance with further aspects of the general inventive concepts, a coating composition comprising is provided that includes about 0.5 to less than 5.0 wt. % solids of a film former comprising one or more of polyvinylpyrrolidone, polyvinyl acetate, polyurethane, and epoxy. The coating composition further includes at least one compatibilizer comprising one or more of a silicone-based coupling agent, a titanate coupling agent, and a zirconate coupling agent. The coating composition has a total solids content of no greater than 5 wt. %.

### DESCRIPTION OF THE DRAWINGS

Various aspects of the general inventive concepts will be more readily understood from the description of certain exemplary embodiments provided below and as illustrated in the accompanying drawings.

FIG. 1 illustrates the results of a “drape test” performed on various reinforcement fibers.

FIG. 2 graphically illustrates the range of stiffness achieved by surface treated carbon fiber (both ribbon and multi-end roving), compared to an otherwise identical untreated carbon fiber ribbon.

FIG. 3 graphically illustrates the range of stiffness achieved by surface treated multi-end glass fiber roving, compared to an otherwise identical untreated multi-end glass fiber roving.

### DETAILED DESCRIPTION

While the general inventive concepts are susceptible of embodiment in many different forms, there are shown in the drawings and will be described herein in detail specific embodiments thereof with the understanding that the present disclosure is to be considered as an exemplification of the principles of the general inventive concepts. Accordingly, the general inventive concepts are not intended to be limited to the specific embodiments illustrated herein.

Unless otherwise defined, the terms used herein have the same meaning as commonly understood by one of ordinary skill in the art encompassing the general inventive concepts. The terminology used herein is for describing exemplary embodiments of the general inventive concepts only and is not intended to be limiting of the general inventive concepts. As used herein, the singular forms “a,” “an,” and “the” are intended to include the plural forms as well, unless the context clearly indicates otherwise. The term “about” means within +/− 10% of a value, or more preferably, within +/− 5% of a value, and most preferably within +/− 1% of a value.

As used herein, the term “wetting” refers to the ability of the resin to bond to and uniformly spread over and bond to the fiber surface. Wetting results from the intermolecular interactions between a liquid and a solid surface.

As used herein, the term “tow” refers to a large collection of filaments, which are typically formed simultaneously and optionally coated with a sizing composition. A tow is designated by the number of fiber filaments they contain. For example, a 12 k tow contains about 12,000 filaments.

As used herein, the term “roving” means a collection of parallel strands (assembled roving) or parallel continuous filaments (direct roving) assembled without intentional twist. A roving includes both single-end roving and multi-end roving (“MER”). A single-end roving is a single bundle of continuous filaments combined into a discrete strand. A multi-end roving is made up of a plurality of discrete strands, each strand having a plurality of continuous filaments. The phrase “continuous” as used herein in connection with filaments, strands, or rovings, means that the filaments, strands, or rovings generally have a significant length but should not be understood to mean that the length is perpetual or infinite.

The present invention relates to methods of imparting increased, tunable stiffness reinforcement fibers, such as carbon fibers. The reinforcement fibers may include any type of fiber suitable for providing desirable structural qualities, and in some instances enhanced thermal properties as well, to a resulting composite. Such reinforcing fibers may be organic, inorganic, or natural fibers. In some exemplary embodiments, the reinforcement fibers are made from any one or more of glass, carbon, aramid, polyesters, polyolefins, polyamides, silicon carbide (SiC), boron nitride, and the like. In some exemplary embodiments, the reinforcement fibers include one or more of glass, carbon, and aramid fibers. In some exemplary embodiments, the reinforcement fibers are carbon fibers. It is to be appreciated that although the present application will often refer to the reinforcement fibers as carbon fibers, the reinforcement fibers are not so limited and may alternatively or additionally comprise any of the reinforcement fibers described herein or otherwise known in the art (now or in the future).

Carbon fibers are generally hydrophobic, conductive fibers that have high tensile strength, high temperature tolerance, and low thermal expansion, and are generally light weight, making them popular in forming reinforced composites. However, carbon fibers may cause processing difficulties, leading to slower and more costly product manufacturing. For instance, conventional carbon fibers typically droop and curve downward due to gravity when held parallel to the ground. Due to this lack of stiffness, the fibers are difficult to chop and utilize in downstream manufacturing processes. Further issues include the tendency for the fibers to break and/or fray during the rubbing, pulling, and spreading motions that occur during processing. Such breaking and fraying may lead to the release of particles into the atmosphere and the formation of “fuzz” on the fibers. In addition to processing difficulties, carbon fibers are hydrophobic and tend to agglomerate, making them harder to wet than hydrophilic glass fibers in traditional matrices.

Carbon fibers may be turbostratic or graphitic, or have a hybrid structure with both turbostratic and graphitic parts present, depending on the precursor used to make the fibers. In turbostratic carbon fibers, the sheets of carbon atoms are haphazardly folded, or crumpled together. Carbon fibers derived from polyacrylonitrile (PAN) are turbostratic, whereas carbon fibers derived from mesophase pitch are graphitic after heat treatment at temperatures exceeding 2,200° C. In some exemplary embodiments, the carbon fibers of the present invention are derived from PAN.

In some exemplary embodiments, the reinforcement fibers of the present invention are coated with a sizing composition to protect the fibers during handing, improve mechanical properties, and/or promote thermal and hydrolytic stability. A sizing composition may also form surface functional groups to promote improved chemical bonding and homogenous mixing within a polymer matrix. Homogenous mixing of the fibers or “wetting” within a polymer matrix material is a measure of how well the reinforcement material is encapsulated by the polymer matrix. It is desirable to have the reinforcement fibers completely wet with no dry fibers. Incomplete wetting during this initial processing can adversely affect subsequent processing as well as the surface characteristics of the final composite.

The sizing composition may be applied to the reinforcement fibers at anytime during the fiber formation process (e.g., prior to packaging or storing of the formed fibers) in an amount from about 0.5% to about 5% by weight solids of a fiber, or from about 1.0% to about 2.0% by weight solids of the fiber. Alternatively, the fibers may be coated with the sizing composition after the fibers have been formed (e.g., after the fibers have been packaged or stored). In some exemplary embodiments, the sizing composition is an aqueous-based composition, such as a suspension or emulsion. The sizing composition may comprise at least one film former. The film former holds individual filaments together to aid in the formation of the fibers and protect the filaments from damage caused by abrasion including, but not limited to, inter-filament abrasion. Acceptable film formers include, for example, polyvinyl acetates, polyurethanes, modified polyolefins, polyesters, epoxides, and mixtures thereof. The film former also helps to enhance the bonding characteristics of the reinforcement fibers with various resin systems. In some exemplary embodiments, the sizing composition helps to compatibilize the reinforcement fibers with an epoxy, polyurethane, polyester, nylon, phenolic, and/or vinyl ester resin.

Referring specifically to carbon fibers, such fibers are frequently supplied in the form of a continuous tow wound onto a reel. Each carbon filament in the tow is a continuous cylinder with a diameter of about 5 μm to about 10 μm. Carbon tows come in a wide variety of sizes, from 1 k, 3 k, 6 k, 12 k, 24 k, 50 k, to greater than 50 k, etc. The k value indicates the number of individual carbon filaments within the tow. For instance, a 12 k tow consists of about 12,000 carbon filaments, while a 50 k tow consists of about 50,000 carbon filaments.

To obtain fine tows (e.g., 12 k or smaller), the carbon must either be manufactured as a fine carbon tow or a larger carbon tow must be split to reduce its filament count. Splitting a high carbon tow (e.g., 24 k, 50 k, or larger) into smaller splits (e.g., less than 12 k) facilitates providing better impregnation with resin and better dispersion when the tow is processed.

In some exemplary embodiments, the carbon fiber tow may be spread to disassociate individual carbon filaments and begin to create a plurality of thinner bundles. The spread carbon fibers may then be pulled under tension to maintain consistent spreading and to further increase the spread between the fibers. For example, a plurality of carbon fibers having widths of about ⅜″ to about ½″ may be pulled along a variety of rollers under tension to form spreads between about ¾″ to about 1½″. The angles and radius of the rollers should be set to maintain a tension that is not too high, which could pull the spread fibers back together.

It has been discovered that surface treating reinforcement fibers at any time during the formation or processing of reinforcement fibers works to increase the stiffness and improve the processability of the fibers. The surface treatment may be applied at the time of reinforcement fiber formation, such as when PAN is converted to carbon fiber. Alternatively, or additionally, the surface treatment may be applied after the reinforcement fiber is sized with a sizing composition and at least partially cured. Alternatively, additionally, the surface treatment may be applied after reinforcement fibers are further processed, such as after carbon fibers are spread and/or split into smaller fiber bundles.

As used herein, the surface treatment may come in many forms, such as a coating composition. Exemplary coating compositions are disclosed in PCT/US16/55936, the disclosure of which is incorporated herein by reference in its entirety. The surface treatment may further comprise a heat treatment, which works to facilitate crosslinking of chemistry present on the fibers from prior application of a sizing composition. In some exemplary embodiments, the heat treatment occurs via passing the fibers over a heated roller or by use of heated air, such as an oven. In some exemplary embodiments, the surface treatment comprises exposing a fiber having a sizing composition previously coated thereon to an environment of high humidity, whereby through the addition of moisture, the chemistry present on the fibers forms crosslinks. In other exemplary embodiments, the surface treatment may include a physical treatment and/or a plasma treatment.

In some exemplary embodiments, the surface treatment is an aqueous coating composition comprising about 2.5 wt. % to about 5.0 wt. % solids, or from about 3.0 wt. % to about 4.5 wt. % solids, or from about 3.5 wt. % to about 4.0 wt. % solids, based on the total solids content of the aqueous composition. Once applied to the fibers, the coating composition has a solids content of about 0.1 wt. % to about 5.0 wt. %, or in an amount from about 0.5 wt. % to about 2.0 wt. % active strand solids, or from about 0.5 wt. % to about 1.0 wt. % active strand solids.

In some exemplary embodiments, the aqueous coating composition comprises at least one film former. For example, the coating composition may comprise one or more of polyvinylpyrrolidone (PVP), polyvinylacetate (PVA), polyurethane (PU), and epoxy as a film forming agent.

Polyvinylpyrrolidone exists in several molecular weight grades characterized by K-value. For example, and not by way of limitation, PVP K-12 has a molecular weight of about 4,000 to about 6,000; PVP K-15 has a molecular weight of about 6,000 to about 15,000; PVP K-30 has a molecular weight of about 40,000 to about 80,000; and PVP K-90 has a molecular weight of about 1,000,000 to about 1,700,000. In some exemplary embodiments, the film former comprises PVP K-90.

The film former may be present in the coating composition in an amount from about 0.5 wt. % to about 5.0 wt. %, or from about 1.0 wt. % to about 4.75 wt. %, or from about 3.0 wt. % to about 4.0 wt. %, based on the total solids content of the aqueous composition. Once applied to the fiber strands, the film former may be present in an amount from about 0.1 wt. % to about 2.0 wt. % by strand solids, or about 0.3 wt. % to about 0.6 by wt. % by strand solids.

In some exemplary embodiments, the coating composition additionally includes a compatibilizer. A compatibilizer may provide a variety of functions synergystically between the film former, the reinforcement (e.g., carbon) fiber, and a resin interface. In some exemplary embodiments, the compatibilizer comprises a coupling agent, such as a silicone-based coupling agent (e.g., silane coupling agents), a titanate coupling agent, or a zirconate coupling agent. Silane coupling agents are conventionally used in sizing compositions for inorganic substrates having hydroxyl groups than can react with the silanol-containing reactive groups. Although such coupling agents have been traditionally used in sizing compositions for glass fibers, alkali metal oxides and carbonates do not form stable bonds with Si—O. However, it has been surprisingly discovered that utilizing such coupling agents in the present surface treatment composition does in fact function to enhance the adhesion of the film forming polymers to the non-glass (i.e., carbon) fibers and reduce the level of fuzz, or broken fiber filaments, during subsequent processing and splitting. Examples of silane coupling agents, which may be suitable for use in the coating composition, include those characterized by the functional groups acryl, alkyl, amino, epoxy, vinyl, azido, ureido, and isocyanato.

Suitable silane coupling agents for use in the coating composition include, but are not limited to, γ-aminopropyltriethoxysilane (A-1100), n-trimethoxy-silyl-propyl-ethylene-diamine (A-1120), γ-methacryloxypropyltrimethoxysilane (A-174), γ-glycidoxypropyltrimethoxysilane (A-187), methyl-trichlorosilane (A-154), methyl-trimethoxysilane (A-163), γ-mercaptopropyl-trimethoxy-silane:(A-189), bis-(3-[triethoxysilyl]propyl)tetrasulfane (A-1289), γ-chloropropyl-trimethoxy-silane (A-143), vinyl-triethoxy-silane (A-151), vinyl-tris-(2-methoxyethoxy)silane (A-172), vinylmethyldimethoxysilane (A-2171), vinyl-triacetoxy silane (A-188), octyltriethoxysilane (A-137), methyltriethoxysilane (A-162), polyazamide silane (A-1387), and gamma-ureidopropyltrialkoxysilane (A-1160).

In some exemplary embodiments, the compatibilizer comprises a mixture of two or more silane coupling agents. For instance, the compatibilizer may include a mixture of aminopropyltriethoxysilane (A-1100) and one or more of methyl-trimethoxysilane (A-163) and γ-methacryloxypropyltrimethoxysilane (A-174). In some exemplary embodiments, the compatibilizer includes one or more of polyazamide silane (A-1387) and gamma-ureidopropyltrialkoxysilane (A-1160).

In some instances, the compatibilizer includes A-1100 and A-163 in a ratio of about 1:1 to about 3:1. In some instances, the compatibilizer includes A-1100 and A-174 in a ratio of about 1:1 to about 3:1.

In some exemplary embodiments, the compatibilizer comprises an organic dialdehyde. Exemplary dialdehydes include gluteric dialdehyde, glycoxal, malondialdehyde, succidialdehyde, phthaladldehyde, and the like. In some exemplary embodiments, the organic dialdehyde is gluteric dialdehyde.

In some exemplary embodiments, the compatibilizer comprises one or more antistatic agents, such as a quaternary ammonium antistatic agent. The quaternary ammonium antistatic agent may comprise triethylalkyletherammonium sulfate, which is a trialkylalkyetherammonium salt with trialkyl groups, 1-3 carbon atoms, alkylether group with alkyl group of 4-18 carbon atoms, and ether group of either ethylene oxide or propylene oxide. An example of a triethylalkyletherammonium sulfate is EMERSTAT 6660A.

The compatibilizer may be present in the coating composition in an amount from about 0.05 wt. % to about 5.0 wt. % active solids, or in an amount from about 0.1 wt. % to about 1.0 wt. % active solids, or from about 0.2 wt. % to about 0.7 wt. % active solids. In some exemplary embodiments, the compatibilizer is present in the coating composition in an amount from about 0.3 wt. % to about 0.6 wt. % active solids.

In some exemplary embodiments, the coating composition has a pH of less than about 10. In some exemplary embodiments, the coating composition has a pH between about 3 and about 7, or between about 4 and about 6, or between about 4.5 and about 5.5.

Excess coating composition remaining on the fibers may be removed to at least partially dry the fibers. The fibers may be dried by any method known or practiced in the art.

In some exemplary embodiments, the surface treated fibers may be dried, such as by pulling the fibers through a dryer, such as an oven. In some exemplary embodiments, the oven is an infrared or convection oven. The oven may be a non-contact oven, meaning that the carbon fiber tow is pulled through the oven without being contacted by any part of the oven. The oven temperature may be any temperature suitable for properly drying the coating composition on the carbon fibers. In some exemplary embodiments, the oven temperature is from about 230° F. to about 600° F., or from about 300° F. to about 500° F.

Once dried, the surface treated fibers may be wound by a winder to produce a high stiffness fiber package, or the fibers may be immediately utilized in a downstream process, such as for compounding with a thermoplastic composition in a long fiber thermoplastic compression molding process, or chopped for use in a compounding process, such as SMC. In some exemplary embodiments, the surface treated, high stiffness fiber tow is utilized to produce a hybrid assembled roving, as described in PCT/US15/54584, the disclosure of which is incorporated herein by reference.

In the formation of fiber reinforced composites, prepregs, fabrics, nonwovens, and the like, the polymer resin matrix material may comprise any suitable thermoplastic or thermosetting material, such as polyester resin, vinyl ester resin, phenolic resin, epoxy, polyimide, and/or styrene, and any desired additives such as fillers, pigments, UV stabilizers, catalysts, initiators, inhibitors, mold release agents, viscosity modifiers, and the like. In some exemplary embodiments, the thermosetting material comprises a styrene resin, an unsaturated polyester resin, or a vinyl ester resin. In structural SMC applications, the polymer resin film may comprise a liquid, while in Class A SMC applications, the polymer resin matrix may comprise a paste.

In some exemplary embodiments, the surface treatment imparts an increased stiffness to the reinforcement fibers. For example, reinforcement fibers that have been surface treated demonstrate at least a 50% increase in stiffness, or at least a 60% increase in stiffness, or at least a 70% increase in stiffness, or at least a 80% increase in stiffness, or at least a 90% increase in stiffness, or at least a 100% increase in stiffness, compared to an otherwise identical reinforcement fiber that has not been surface treated. The degree of stiffness imparted to the fibers is tunable (i.e., adjustable property).

In some exemplary embodiments, the surface treatment imparts increased loft in reinforcement fibers that have been chopped. A higher chop loft creates higher chop density, which may impact the ability of chopped fibers to wet-out in a resin matrix material. Particularly, with reference to carbon fibers, a carbon fiber tow may be split into a plurality of thinner carbon fiber bundles, each comprising no greater than about 15,000 (15 k) carbon filaments. Such split carbon fiber tows further increase the density of the chop loft. In some exemplary embodiments, the carbon fiber bundles comprise less than about 12,000 carbon filaments, or less than about 10,000 carbon filaments, or less than about 9,000 carbon filaments, or less than about 8,000 carbon filaments, or less than about 7,000 carbon filaments, or less than about 6,000 carbon filaments, or less than about 5,000 carbon filaments, or less than about 4,000 carbon filaments, or less than about 3,000 carbon filaments, or less than about 2,000 carbon filaments, or less than about 1,000 carbon filaments. In some exemplary embodiments, the carbon fiber tow comprises from about 1,000 to about 12,000 carbon filaments, or from about 2,000 to about 6,000 carbon filaments, or from about 2,000 to about 3,000 carbon filaments. The carbon fiber bundles have a diameter of about 0.5 mm to about 4.0 mm, or about 1.0 mm to about 3.0 mm.

In some exemplary embodiments, the surface treatment improves the compatibility of the reinforcement fibers with a polymeric resin matrix material for composite production. Compatibilizing the carbon fibers with a matrix material allows the carbon fibers to flow and wet properly, forming a substantially homogenous dispersion of carbon fibers within the polymer matrix material. The surface treatment also imparts increased cohesion, which allows for improved chopping of the fibers and improved wetting in the consolidation process.

Moreover, the surface treatment improves the ability to process a carbon fiber tow by reducing the development of fuzz, fiber breakage, and/or fiber fraying, over otherwise identical carbon fibers that are only coated with the sizing composition. When carbon fibers are chopped for downstream processing, the formation of fuzz works against dispersion of the chopped fibers in a matrix material. Accordingly, by surface treating the carbon fibers, the formation of fuzz is reduced, which improves fiber dispersion.

As mentioned above, it has been discovered that the surface treatment may be adjusted to “tune” the particular properties achieved by the treated fibers. For example, the surface treatment may adjusted to increase or decrease the level of fiber stiffness and/or the level of loft. Such adjustments include increasing or decreasing the surface treatment solids content (LOI), exposing the surface treated fibers to varying temperatures at varying speeds, adjusting the moisture content of the surface treated fibers, adjusting the angle of contact points that the fibers encounter, changing the particular type of surface treatment applied to the fibers, and/or combining various surface treatments.

In some exemplary embodiments, the stiffened reinforcement fibers are utilized as large, stiff ribbons (at least 24 k) in the formation of composite, such as in the formation of wind turbine blades. Due to the use of the surface treatments disclosed herein, the stiff fiber ribbons have a low solids content (0.5 wt. % to 3.0 wt. % solids), which leads to improved composite properties.

The stiffened reinforcement fibers may then be used in the formation of reinforcement materials, such as reinforced composites, prepregs, fabrics, nonwovens, and the like. In some exemplary embodiments, the coated fibers may be used in sheet molding compound (“SMC”) applications, for forming an SMC material. In an SMC production process, a layer of a polymer film, such as a polyester resin or vinyl ester resin premix, is metered onto a plastic carrier sheet that includes a non-adhering surface. Reinforcing fibers are then deposited onto the polymer film and a second, non-adhering carrier sheet containing a second layer of polymer film is positioned onto the first sheet such that the second polymer film contacts the reinforcing fibers and forms a sandwiched material. This sandwiched material is then kneaded to distribute the polymer resin matrix and fiber bundles throughout the resultant SMC material, which may then be rolled for later use in a molding process.

In the production of SMC compounds, it is desirable that the reinforcement material homogeneously contact and mix within the polymeric matrix material. One measure of this homogenous mixing is referred to as wetting, which is a measure of how well the reinforcement material is encapsulated by the matrix resin material. It is desirable to have the reinforcement material completely wet with no dry fibers. Incomplete wetting during this initial processing can adversely affect subsequent processing as well as the surface characteristics of the final composite. For example, poor wetting may result in poor molding characteristics of the SMC, resulting in low composite strengths and surface defects in the final molded part. The SMC manufacturing process throughput, such as lines-speeds and productivity, are limited by how well and how quickly the fibers can be completely wet.

The SMC material may then be stored for 2-5 days to permit the resin to thicken and mature. During this maturation time, the SMC material increases in viscosity within the range of about 15 million centipoise to about 40 million centipoise.

Once the SMC material has reached the target viscosity the SMC material may be cut and placed into a mold having the desired shape of the final product. The mold is heated to an elevated temperature and closed to increase the pressure. This combination of high heat and high pressure causes the SMC material to flow and fill out the mold. The matrix resin then goes through a period of maturation, where the material continues to increase in viscosity as a form of chemical thickening or gelling. Exemplary molded composite parts formed using the coated reinforcement fibers may include exterior automotive body parts and structural automotive body parts.

In some exemplary embodiments, the resulting SMC material has a tensile modulus of between about 10 GPa and about 35 GPa, or from about 15 GPa to about 30 GPa including all combinations and sub-ranges contained therein. In other exemplary embodiments, the resulting SMC material has a tensile modulus of about 22 GPa to about 29 GPa, or about 26 GPa including all combinations and sub-ranges contained therein.

In some exemplary embodiments, the resulting SMC material has a tensile strength of between about 50 MPa and about 300 MPa, or from about 100 to about 250 MPa, including all combinations and sub-ranges contained therein. In other exemplary embodiments, the resulting SMC material has a tensile strength of about 160 MPa and about 210 MPa, or about 200 MPa, including all combinations and sub-ranges contained therein.

In some exemplary embodiments, the resulting SMC material has a flexural modulus of between about 10 GPa to about 40 GPa, including about 12 GPa to about 35 GPa, about 15 GPa to about 30 Gpa, including from about 21 GPa to about 26 GPa, including all combinations and sub-ranges contained therein. In other exemplary embodiments, the resulting SMC material has a flexural strength of about 200 MPa to about 500 MPa, including about 250 MPa to about 400 MPa, about 300 MPa to about 360 MPa, and about 3200 to about 345 MPa, including all combinations and sub-ranges contained therein.

Having generally described various aspects of the general inventive concepts, a further understanding can be obtained by reference to certain specific examples illustrated below. These examples are provided for purposes of illustration only and are not intended to be limiting unless otherwise specified.

### EXAMPLES

A “drape test” was performed on fibers that were treated with a surface treatment and fibers that were untreated. The surface treatment was a coating composition that included a PVP film former and was applied at an LOI of approximately 2.0%. During the drape test, the fibers were cut to a length of 8 inches. The fibers were attached to a measurement stick (e.g., ruler) and the distance measured along the x-axis was measured. Using this measurement, a perfectly straight fiber would measure 8 inches across, while a fiber that droops downward would measure less, due to the force of gravity overcoming the fiber's stiffness and pulling it down.

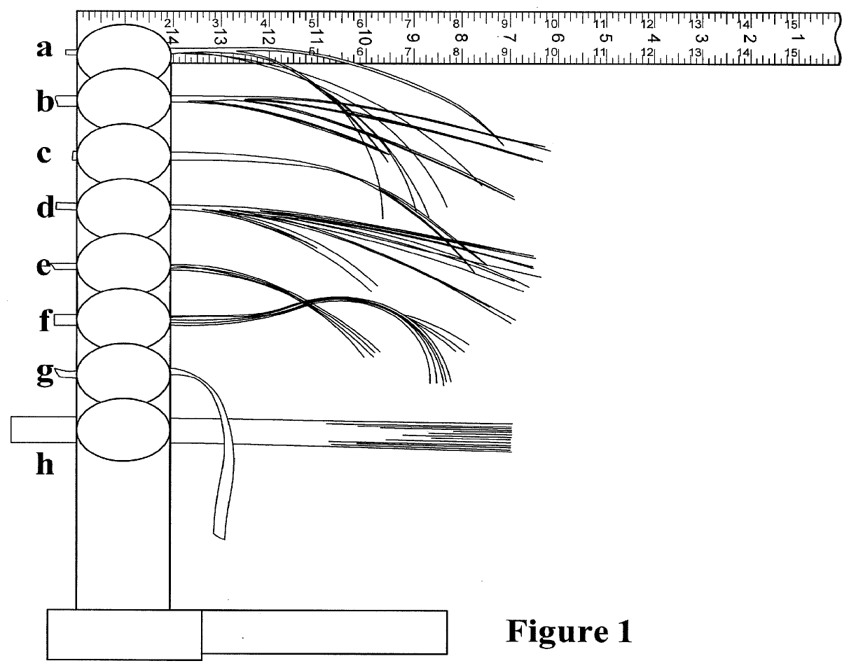

FIG. 1 illustrates the various reinforcement fibers that were subjected to the drape test. It should be noted that, other than the surface treated carbon fiber ribbon, each of the samples in FIG. 1 were tested after being wound, such that a portion of the stiffness falloff may be attributed to the winding process. As shown in FIG. 1, the untreated carbon fiber tow (g) measured about 3.75 inches to the tip horizontally from the drape point. In contrast, a surface treated carbon fiber tow (c) and 50 k surface treated carbon fiber ribbon (h) measured about 7.25 to 8 inches, which is a 93% to 113% increase in stiffness. Similarly, the surface treated glass multi-end roving (f) measured about 7.875 to 8 inches, as compared to an otherwise identical glass multi-end roving that was not surface treated (e), measuring at 4.25 to 6 inches. This demonstrates an increase in stiffness of 33 to 85%. A hybrid assembled roving (d) (comingled glass and surface treated carbon multi-end roving) measured at about 4.875 to 7.5 inches (glass) and 7.625 to 8.0 inches (surface treated carbon). Additionally, each of a 6 k surface treated carbon fiber (b) and a 2 k surface treated carbon fiber tow (a) measured above 6.0 inches, as compared to the untreated carbon ribbon (g) with a measurement of 3.75 inches. Table 1 details this information, below.

TABLE 1

| Converted Fibers | Min | Max |
|---|---|---|
| (e) Glass MER | 4.25 | 6 |
| (f) Coated Glass | 7.875 | 8 |
| MER* | | |
| (g) Uncoated carbon | 3.75 | |
| ribbon 24k | | |
| (c) Coated Carbon | 7.25 | 8 |
| Ribbon | | |
| (d) HAR | | |
| Glass | 4.875 | 7.5 |
| Carbon | 7.625 | 8 |
| (b) Coated/Split 6k | 7.375 | 7.875 |
| (a) Coated/Split 2k | 6.5 | 7.625 |

*Note:
Coated Glass MER x-distance adjusted to represent stiffness

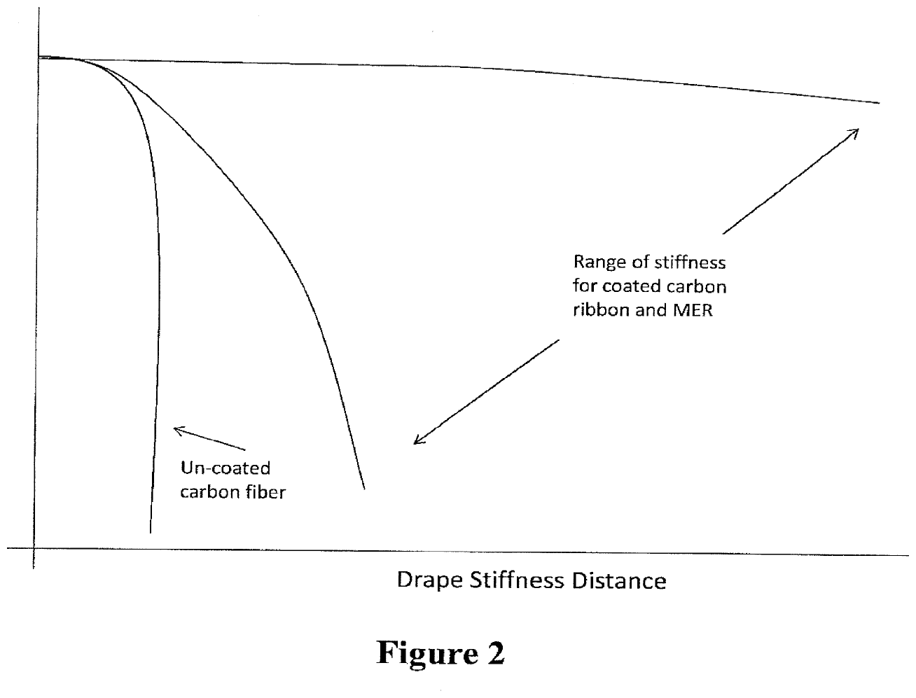

As illustrated in FIG. 2, surface treated carbon fiber (both multi-end carbon fiber and a carbon fiber ribbon) achieved a range of tunable stiffness that is improved over the stiffness of an otherwise identical carbon fiber that was not surface treated (“as received” carbon fiber).

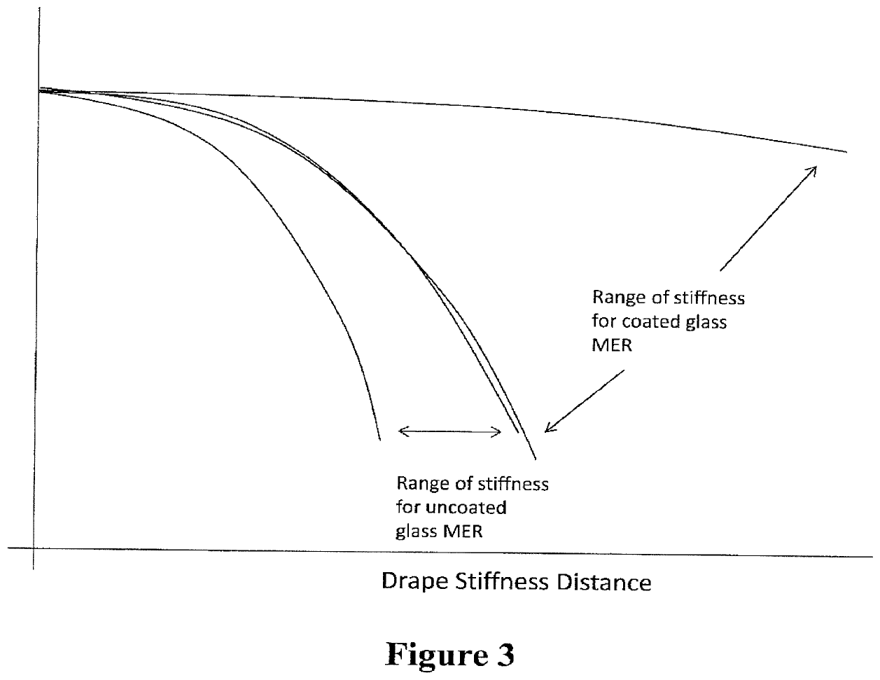

As illustrated in FIG. 3, surface treated multi-end glass fiber rovings achieved a range of tunable stiffness that is increased over a range of stiffness for an otherwise identical glass fiber that was not surface treated (“as received” glass fiber).

Although various exemplary embodiments have been described and suggested herein, it should be appreciated that many modifications can be made without departing from the spirit and scope of the general inventive concepts. All such modifications are intended to be included within the scope of the invention, which is to be limited only by the following claims.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods may comprise, consist of, or consist essentially of the process steps described herein, as well as any additional or optional process steps described herein or otherwise useful.

In some embodiments, it may be possible to utilize the various inventive concepts in combination with one another (e.g., one or more of the first, second, etc., exemplary embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

1. A reinforcement fiber comprising:
a surface treatment having a solids content of about 2.5 wt. % to about 5.0 wt. %, said surface treatment comprising about 0.5 to 5.0 wt. % of at least one film former and at least one compatibilizer comprising one or more of a silicone-based coupling agent, a titanate coupling agent, and a zirconate coupling agent, said reinforcement fiber having a stiffness that is at least 50% higher than an otherwise identical reinforcement fiber that has not been surface treated.

2. The reinforcement fiber of claim 1, wherein said film former comprises one or more of polyvinylpyrrolidone (PVP), polyvinylacetate (PVA), polyurethane (PU), and epoxy.

3. The reinforcement fiber of claim 2, wherein said polyvinylpyrrolidone has a molecular weight of 1,000,000 to 1,700,000.

4. The reinforcement fiber of claim 1, wherein said reinforcement fiber comprises carbon.

5. The reinforcement fiber of claim 1, wherein the reinforcement fiber has a stiffness that is at least 80% higher than an otherwise identical reinforcement fiber that has not been surface treated.

6. The reinforcement fiber of claim 1, wherein said surface treatment has a solids content of about 0.5 to about 3.0 wt. %.

7. A stiffened carbon fiber bundle comprising:
a plurality of carbon reinforcement fibers according to claim 4, wherein said stiffened carbon fiber bundle comprises no greater than 15,000 filaments.

8. The stiffened carbon fiber bundle of claim 7, wherein said carbon fiber bundle comprises no greater than 12,000 filaments.

9. The stiffened carbon fiber of claim 7, wherein said carbon fiber bundle comprises between about 1,000 and about 6,000 filaments.

10. A stiffened carbon fiber ribbon comprising:
a plurality of carbon reinforcement fibers according to claim 4, wherein said stiffened carbon fiber ribbon comprises at least 24,000 filaments.

11. A method for increasing the stiffness of a reinforcement fiber, said method comprising:
applying a surface treatment to the reinforcement fibers, wherein said surface treatment comprises one or more of a coating composition, heat treatment, and exposure to humidity, wherein said surface treatment increases the stiffness of the reinforcement fiber by at least 50% compared to an otherwise identical reinforcement fiber that has not been surface treated.

12. The method of claim 11, wherein said reinforcement fiber comprises at least one of glass, carbon, aramid, polyesters, polyolefins, polyamides, silicon carbide (SiC), and boron nitride fibers.

13. The method of claim 11, wherein said reinforcement fibers are carbon fibers.

14. A fiber-reinforced composite comprising a plurality of reinforcement fibers according to claim 1; and
a polymer resin material, wherein said reinforcement fibers have a stiffness that is at least 50% higher than an otherwise identical reinforcement fiber that has not been surface treated.

15. A coating composition comprising:
about 0.5 to less than 5.0 wt. % solids of a film former comprising one or more of polyvinylpyrrolidone, polyvinyl acetate, polyurethane, and epoxy; and
at least one compatibilizer comprising one or more of a silicone-based coupling agent, a titanate coupling agent, and a zirconate coupling agent, wherein said coating composition has a total solids content of no greater than 5 wt. %.

16. The coating composition of claim 15, wherein said film former comprises one or more of polyvinylpyrrolidone (PVP), polyvinylacetate (PVA), polyurethane (PU), and epoxy.

17. The coating composition of claim 16, wherein said polyvinylpyrrolidone has a molecular weight of 1,000,000 to 1,700,000.
